(19) United States
(12) Patent Application Publication
(10) Pub. No.: US 2023/0220870 A1
(43) Pub. Date: Jul. 13, 2023

(54) Simple and convenient slef-locking nut

(71) Applicant: Chunlin YE, Yiwu, Zhejiang (CN)

(72) Inventor: Chunlin YE, Yiwu, Zhejiang (CN)

(21) Appl. No.: 17/916,322

(22) PCT Filed: Mar. 10, 2021
(86) PCT No.: PCT/CN2021/080019

§ 371 Date: Sep. 30, 2022

(30) Foreign Application Priority Data
Mar. 9, 2021 (CN) 202010241948.1

(51) Int. Cl. F16B 39/36

(52) U.S. Cl. CPC F16B 39/36

(57) ABSTRACT

Provided is a simple and convenient self-locking nut. The simple and convenient self-locking nut consists of a concave nut (1) having a tapered-cylinder-shaped recess and a matching convex nut (2) having a tapered-cylinder-shaped protrusion, wherein a tapered-cylinder-shaped part of the matching nut is provided with a matching spiral progressive locking structure, a convex part of the convex nut is provided with open through grooves, thus forming an intermittent annular progressive locking structure, such that the convex part of the nut locks a bolt (3) while being locked with the concave nut (1), or locking is so tight that intermittent occlusion is formed with a thread of the bolt (3) to enhance the locking efficiency of the bolt (3); and the two nuts and the tapered-cylindrical and annular progressive tightening structure guarantee uniform stress, thus ensuring the reliability of the overall efficacy, and the expected goal that the nut will not come loose after being locked is achieved without affecting the normal characteristics of the bolt.

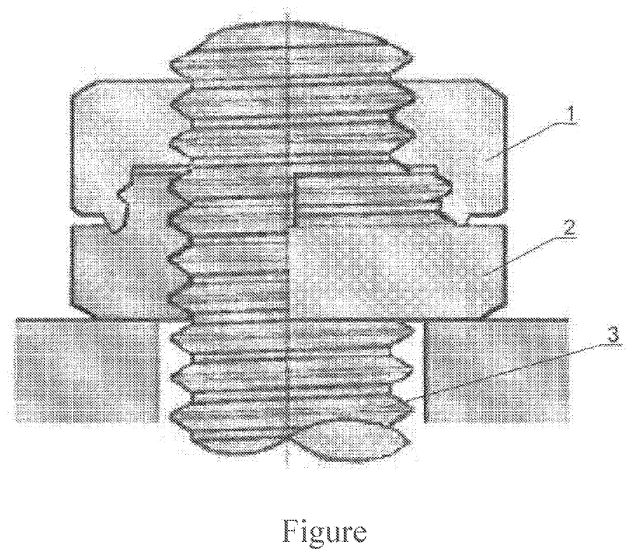

### TECHNICAL FIELD

The present invention relates to the field of self-locking of bolts and nuts, in particular to a simple and convenient self-locking nut.

### BACKGROUND

Bolts and nuts can be seen everywhere in daily life and work as they are the most commonly used fixing parts in various equipment. Screws are also called “the rice of industry”. Although they look tiny, their function is by no means small. Especially in some safety-sensitive occasions, for example, on high-tech objects, the reliability of bolts and nuts is of great significance. Loosing or falling off of bolts and nuts may cause fatal damage to equipment. How to effectively and reliably prevent the loosening of bolts and nuts is a concrete problem that we face, and quite a few products and technical schemes are available to deal with this issue. However, different application occasions have different requirements, and various existing self-locking bolts and nuts all have their own merits, for example, the Hardlock Nut that “never comes loose” which, according to some reviews online, “consists of two nuts, with the second nut being tightened onto the first one under eccentric pressure to realize the self-locking purpose”. However, there is a problem which is not hard for experienced engineers to realize. That is, when the eccentric pressure is applied, thread engagement between the nut and the bolt will inevitably incline to one side, and the stress on the thread will be uneven. Further, besides normal tensile stress, the bolt is also subjected to bending stress, which will seriously affect the fatigue strength of the fastener. When working under an alternating force for a long time, the fatigue life of the bolt will be inevitably reduced. For key engine parts like link rods, cylinder heads and flywheels which have high requirements for fatigue strength, Hardlock fasteners are not suitable. Therefore, highly reliable and universal self-locking nuts are desirable.

### SUMMARY

The present invention aims to solve the problem that the prior art is insufficient in preventing a nut from coming loose, and provides a simple and convenient self-locking nut which is reasonable, reliable, easy to operate and universal.

To achieve the above objective, the present invention adopts the following technical scheme. A simple and convenient self-locking nut consists of a concave nut having a tapered-cylinder-shaped recess and a matching convex nut having a tapered-cylinder-shaped protrusion, wherein a tapered-cylinder-shaped part of the matching nut is provided with a matching spiral progressive locking structure, a convex part of the outer tapered-cylinder-shaped nut is provided with open through grooves, thus forming an intermittent annular progressive locking structure, such that the convex part of the nut locks a bolt while being locked with the concave nut, or locking is so tight that intermittent occlusion is formed with the thread of the bolt to enhance the locking efficiency of the bolt; the two nuts and the tapered-cylindrical and annular progressive tightening structure guarantee uniform stress, thus ensuring the reliability of the overall efficacy, and the expected goal that the nut will not loosen after being locked is achieved without affecting the normal characteristics of the bolt; further, matching annular convex-concave pressing reinforcing ribs are arranged on contact faces of the two nuts which match each other, so as to enhance the reliability and firmness of two-nut locking.

Here, the taper degrees of the tapered-cylinder-shaped recess and the convex part of the two nuts which match each other can be selected according to the spiral progressive locking structure; the spiral progressive locking structure can be a tapered thread type progressive tightening structure or a progressive cam structure featuring intermittent annular uniform distribution according to different nut sizes and application occasions; the number, shape and size of the open through grooves can be determined according to different nut sizes and application occasions, and the open through grooves are arranged in an equal division manner, so as to apply a balanced locking force to the bolt; and the annular convex-concave pressing reinforcing ribs can be arranged into a trapezoid, a semicircle or a triangle easy to machine according to different nut sizes and application occasions, specifically, annular reinforcing rib recesses are formed by extending the convex part with the same taper degree on the convex nut, and annular convex reinforcing ribs matching the annular reinforcing rib recesses are arranged on the concave nut, so as to increase an effective locking press face, the strength of the concave nut and locking. When the application has no strength requirement or a flange nut is used, the tapered-cylinder shape of the concave and convex part of the nut can be changed into a cylindrical shape.

As an improvement, a deviation correction value for eliminating a clearance between the threads of the nut and the bolt can be set for the tapered thread type progressive tightening structure or the progressive cam structure featuring intermittent annular uniform distribution selected for the two nuts which match each other, such that a contact area after locking is increased, the bolt can be locked more reliably, and occlusion can be realized more easily.

As an improvement, for the annular convex-concave pressing reinforcing ribs, annular reinforcing rib recesses are formed by extending the convex part with the same taper degree on the convex nut, and annular convex reinforcing ribs matching the annular reinforcing rib recesses are arranged on the concave nut, so as to increase an effective locking press face, the strength of the concave nut and locking.

As an improvement, the annular convex-concave pressing reinforcing ribs can be in an inclined trapezoidal wedge shape with a bottom angle of R chamfer, so as to increase an effective locking surface of the nut, ensure the strength of the concave nut and improve the locking reliability.

As an improvement, one of or both locking back planes of the two nuts which match each other can be provided with a one-way backstop self-locking structure, so as to enhance the self-locking effect of the nut.

As an improvement, a backstop self-locking elastic washer matching the one-way backstop self-locking structure can be additionally arranged under the nut provided with the one-way backstop self-locking structure, so as to enhance the self-locking effect of the nut.

Aiming at the core of the problem, the invention adopts a reasonable, simple and convenient, reliable and easy-to-realize structure. By using a double-nut spiral progressive structure to lock a bolt in a multi-sided and complementary manner, the defect of a traditional fastener that stress is mostly concentrated on first and second threads after a nut is tightened is overcome, the effective locking area and the bolt locking effect are improved, and step-by-step implementation and flexible operation can be realized according to different situations. More specifically, the whole scheme is characterized by uniform locking stress and high reliability, and the effect that the nut will not loosen after being tightened is realized without affecting the performance of the bolt. What is obviously different from the “eccentric” structure of the Hardlock Nut is that unlike an “eccentric” nut, no forced torsion is applied to the bolt, and effectiveness is not concentrated on a relative torsional line, thus greatly expanding the scope of application.

The present invention has the following beneficial effects. By identifying the essence of the problem, using an effective method, and adopting the spiral progressive locking structure which is reasonable, simple and easy to implement, a bolt is locked in a multi-sided and complementary manner, and the effect that the nut will not loosen is realized without affecting the performance of the bolt.

### BRIEF DESCRIPTION OF DRAWINGS

FIGURE is a schematic diagram of a simple and convenient self-locking nut according to the present invention.

In the accompanying drawings: 1. concave nut 2. convex nut 3. bolt.

### DETAILED DESCRIPTION

A simple and convenient self-locking nut will be further described below with reference to the schematic diagram.

Embodiment: A simple and convenient self-locking nut as shown in FIGURE consists of a concave nut 1 having a tapered-cylinder-shaped recess and a matching convex nut 2 having a tapered-cylinder-shaped protrusion, wherein a tapered-cylinder-shaped part of the matching nut is provided with a matching spiral progressive locking structure, a convex part of the convex nut 2 is provided with open through grooves, thus forming an intermittent annular progressive locking structure, such that the convex part of the nut locks a bolt 3 while being locked with the concave nut 1, or locking is so tight that intermittent occlusion is formed with a thread of the bolt 3 to enhance the locking efficiency of the bolt 3; the two nuts and the tapered and annular progressive tightening structure guarantee uniform stress, thus ensuring the reliability of the overall efficacy, and the expected goal that the nut will not loosen after being locked is achieved without affecting the normal characteristics of the bolt 3; further, matching annular convex-concave pressing reinforcing ribs are arranged on contact faces of the two nuts 1 and 2 which match each other, so as to enhance the reliability and firmness of two-nut (1 and 2) locking; here, the taper degrees of the two nuts 1 and 2 which match each other are determined according to Morse taper, a taper degree deviation correction value of 0.5 degree for eliminating the tooth clearance is adopted between the concave nut 1 and the convex nut 2, and a taper thread progressive locking structure is adopted; the open through grooves are two open through grooves formed by equal division, each having a width of 1 mm; here, for the annular convex-concave pressing reinforcing ribs, annular reinforcing rib recesses in an inclined trapezoidal shape with a small R chamfer are formed by extending the convex part with the same taper degree on the convex nut 2, and annular convex reinforcing ribs in an inclined trapezoidal shape with a small R chamfer matching the reinforcing rib recesses are arranged on the concave nut 1. The main features and preferences listed in the present invention are only the frame expression of the invention for solving technical problems, and can be adjusted, selected and improved as needed to better meet different demands in reality; in order to make the invention more reliable in application, a single wedge-shaped structural member can be added to each open through groove, or an integrated annular wedge-shaped structural member can be specially made according to the number of the open through grooves, so as to enhance the locking effect on the bolt 3; or, in order to facilitate occlusion by the nuts 1 and 2 on the bolt and enhance self-locking, inclined plane structures can be added at the crests of threads of the nuts 1 and 2; and wedge locking parts can be adopted as needed between interrupted threads or uniformly distributed gradually convex structures. In fact, even if “a convex part of the convex nut is provided with open through grooves” as stated in Claim 1 is not true, as long as “a cone-shaped part of the matching nut is provided with a matching spiral progressive locking structure”, this unique tapered threaded structure can meet the requirements of many occasions for preventing nuts from coming loose.

Obviously, those skilled in the art can make various changes to the structural arrangement of the present invention without departing from the spirit of the present invention. Therefore, if these changes fall within the scope of the claims of the present invention and their technical equivalents, the present invention is also intended to cover these changes.

1. A simple and convenient self-locking nut, consisting of a concave nut having a tapered-cylinder-shaped recess and a matching convex nut having a tapered-cylinder-shaped protrusion, wherein a tapered-cylinder-shaped part of the matching nut is provided with a matching spiral progressive locking structure, a convex part of the convex nut is provided with open through grooves, thus forming an intermittent annular progressive locking structure, such that the convex part of the nut locks a bolt while being locked with the concave nut, or locking is so tight that intermittent occlusion is formed with a thread of the bolt to enhance the locking efficiency of the bolt; the two nuts and the tapered-cylindrical and annular progressive tightening structure guarantee uniform stress, thus ensuring the reliability of the overall efficacy, and the expected goal that the nut will not come loose after being locked is achieved without affecting the normal characteristics of the bolt;
further, matching annular convex-concave pressing reinforcing ribs are arranged on contact faces of the concave nut and the convex nut, so as to enhance the reliability and firmness of two-nut locking;
wherein for the taper degrees of the tapered-cylinder-shaped recess of the concave nut and the convex part of the convex nut, one safety factor can be added to a self-locking angle according to different nut sizes and application occasions; the number, shape and size of the open through grooves can be determined according to different nut sizes and application occasions, and the open through grooves are arranged in an equal division manner, so as to apply a balanced locking force to the bolt; and the annular convex-concave pressing reinforcing ribs can be arranged into a trapezoid, a semicircle or a triangle easy to machine according to different nut sizes and application occasions, specifically, annular reinforcing rib recesses are formed by extending the convex part with the same taper degree on the convex nut, and annular convex reinforcing ribs matching the annular reinforcing rib recesses are arranged on the concave nut, so as to increase an effective locking press face, the strength of the concave nut and locking reliability.

2. The simple and convenient self-locking nut of claim 1, wherein a taper degree deviation correction value for eliminating a clearance between the threads of the nut and the bolt can be set on the taper degrees of a tapered-cylinder-shaped recess of the concave nut and the convex part of the matching convex nut, such that the bolt can be locked more tightly and reliably and occlusion can be realized more easily.

3. The simple and convenient self-locking nut of claim 1, wherein the annular convex-concave pressing reinforcing ribs can be in an inclined trapezoidal wedge shape with a bottom angle of R chamfer, so as to increase an effective locking surface of the nut, ensure the strength of the reinforcing ribs and improve the locking reliability.

4. The simple and convenient self-locking nut of claim 1, wherein one of or both locking back planes of the concave nut and the convex nut can be provided with a one-way backstop self-locking structure, so as to enhance the self-locking effect of the nut.

5. The simple and convenient self-locking nut of claim 4, wherein a backstop self-locking elastic washer matching the one-way backstop self-locking structure can be additionally arranged under the nut provided with the one-way backstop self-locking structure, so as to enhance the self-locking effect of the nut.

6. The simple and convenient self-locking nut of claim 1, wherein a single wedge-shaped structural member can be added to each open through groove of the nut, or an integrated annular wedge-shaped structural member can be specially made according to the number of the open through grooves, so as to enhance the locking effect on the bolt.
